(19) United States
(12) Patent Application Publication
(10) Pub. No.: US 2026/0318270 A1
(43) Pub. Date: Oct. 15, 2026

(54) FUEL MIXING TUBE

(71) Applicant: Caterpillar Inc., Peoria, IL (US)

(72) Inventors: Bobby John, Peoria, IL (US); William Barnes, Rapid City, SD (US); Jonathan W. Anders, Peoria, IL (US); Naga Krishna Chaitanya Kavuri, Melissa, TX (US)

(73) Assignee: Caterpillar Inc., Peoria, IL (US)

(21) Appl. No.: 19/173,913

(22) Filed: Apr. 9, 2025

(51) Int. Cl. F02M 35/10; F23R 3/28

(52) U.S. Cl. CPC F02M 35/10216; F02M 35/10262; F23R 3/286; F05D 2240/35

(57) ABSTRACT

A mixing tube assembly for delivering fuel to an internal combustion engine is disclosed. The mixing tube includes a first tube that has a first end segment configured to receive a fuel from a fuel injector. The first tube additionally has a second end segment which is coupled to and empties into a second tube through a third end segment of the second tube. The third end segment is further configured to receive air from a manifold. The second tube also has a fourth end segment which empties into the manifold. The mixing tube is configured to move air from the manifold through the second tube to mix with and evacuate the fuel from the mixing tube.

### TECHNICAL FIELD

The present disclosure relates generally to a fuel mixing tube, and more particularly to a fuel mixing tube for an internal combustion engine.

### BACKGROUND

Internal combustions engines, although typically designed to run on liquid fuels, have been designed or converted to run on a variety of gaseous fuels for a variety of reasons, such as reduced emissions and fuel availability. Internal combustion engines that run on gaseous fuels have been around for many years, such as those that have been designed and converted to run on natural gas and propane. More recently, efforts have been made to expand the use of alternate gaseous fuels to include fuels such as gaseous hydrogen to further reduce or even eliminate certain emissions.

Internal combustion engines using gaseous fuels are generally structurally similar to their liquid fuel counterparts, and generally provide the fuel to the cylinders in a similar manner. One common method is through port-injection, or injecting the fuel into the intake manifold rather than directly into the cylinder. In port-injection, the injected fuel mixes with the air moving through the intake manifold, the mixture pulled into the cylinder where it more completely mixes prior to combustion.

Due to injection and mixing happening while the fuel is already in a gaseous form, rather than in a fully or partially liquid form, gaseous fuels have been shown to provide faster and more complete mixing prior to combustion. Accordingly, gaseous fuels may result in higher combustion efficiency than liquid fuels. However, gaseous fuels may present issues not encountered with liquid fuels. For example, in port-injection, some residual fuel may be left within the fuel delivery line and/or the manifold when the cylinder closes. The residual fuel not pulled into the intended cylinder may subsequently linger within the intake manifold until the cylinder reopens or may be pulled across the intake manifold into a different cylinder.

U.S. Pat. No. 11,649,966B1 describes a turbine engine having a combustion section. The turbine engine includes an ignition tube, the outlet of which extends through a wall of a combustion chamber. The ignition tube includes a fluid channel, an ignition fuel injector, a compressed air passage, and an ignitor. The fluid channel is downstream of the ignition fuel injector and the compressed air passage and contains the ignitor. The ignition fuel injector supplies a flow of fuel into the fluid channel, and the compressed air passage supplies compressed air to the fluid channel. The fuel and compressed air mix in the fluid channel downstream of the ignition fuel injector. The mixture is subsequently combusted by the ignitor and flows out of the ignition tube into the combustion chamber.

The device of the '966 patent is directed to turbine engines, which are designed to run with a continuous flow of fuel to a singular fluid channel, rather than timed injections to a number of different cylinders, as in an internal combustion engine. Further, the fluid channel includes an ignitor, which ignites the mixture within the same fluid channel the fuel is injected into, rather than transferring it to a cylinder for ignition. Accordingly, the injected fuel is burned back to the ignition fuel injector rather than the injected fuel being evacuated from the fuel channel into a separate combustion chamber to be combusted.

### SUMMARY

In an aspect of the present disclosure, a mixing tube assembly is provided for delivering fuel to an internal combustion engine having an intake manifold, the intake manifold including a manifold wall and defining a manifold cavity. The assembly includes a first tube and a second tube, the first tube configured to extend from outside the manifold wall and into the manifold cavity. The first tube includes a first end segment and a second end segment positioned opposite the first end segment. The first end segment is positioned outside of the manifold and is configured to receive a charge of fuel from a fuel injector. The second end segment is configured to be positioned within the manifold cavity. The second tube is configured to be positioned entirely within the manifold cavity and includes a third end segment and a fourth end segment positioned opposite the third end segment. The third end segment receives the second end segment and includes an opening that is in communication with the manifold cavity. The fourth end segment is in communication with the manifold cavity. The mixing tube assembly is configured such that during operation of the internal combustion engine, air from within the manifold cavity flows through the opening and moves the charge of fuel through the second tube.

In another aspect of the present disclosure, there is an internal combustion engine that includes a cylinder, a manifold, an intake valve, a mixing tube assembly, and an injector. The manifold includes a manifold wall and a manifold cavity and is fluidly coupled to the cylinder and is configured to provide air to the cylinder. The intake valve controls the flow of material from the manifold cavity to the cylinder. The mixing tube includes an inner tube and an outer tube.

The inner tube is coupled to the manifold and includes a fuel inlet positioned outside of the manifold cavity and a fuel outlet positioned within the manifold cavity. The outer tube includes an inlet end and an outlet end. The inlet end has a larger diameter than the fuel outlet and is fixedly coupled to the inner tube such that the fuel outlet is entirely within the outer tube. The inlet end further includes an air inlet through which air from the manifold cavity passes into the inlet end. The outlet end opens into the manifold cavity before the intake valve. The injector is coupled to the fuel inlet and provides fuel to the inner tube. During operation of the engine, the fuel from the inner tube is drawn into the outer tube and joins with air moving into the outer tube through the air inlet which forms a mixture that is drawn out of the outer tube and into the manifold cavity. The mixture then joins the air in the manifold cavity and is drawn past the intake valve and into the cylinder.

In yet another aspect of the present disclosure, a method is provided for delivering fuel to an internal combustion engine having an intake valve, a cylinder, a manifold defining a manifold cavity, a mixing tube having an air inlet in constant and unblocked fluid communication with the manifold cavity, and a fuel injector. The method includes opening the intake valve to begin an intake stroke, and then operating the fuel injector to inject a fuel into the mixing tube. Afterwards, air is moved from the manifold cavity into the mixing tube through an opening in the mixing tube, where the fuel in the mixing tube is combined with the air in the mixing tube to form a first mixture. The first mixture is then moved from the mixing tube into the manifold cavity, where the first mixture is combined with the air in the manifold cavity to form a second mixture. The fuel injector is operated to stop the injection of fuel into the mixing tube. The second mixture is moved from the manifold cavity into the cylinder, and air from the manifold cavity is moved into the mixing tube to evacuate residual fuel from the mixing tube. Afterwards, the intake valve is closed and the intake stroke ends.

Other features and aspects of this disclosure will be apparent from the following description and the accompanying drawings.

### BRIEF DESCRIPTION OF DRAWINGS

FIG. 1 is a side view of a power generation unit.

FIG. 2 is a diagrammatic view of an engine intake system of the power generation unit of FIG. 1.

FIG. 3 is a diagrammatic view of a portion of the engine intake system of FIG. 2.

FIG. 4 is a side sectional view of a mixing tube, such as used in the engine intake system of FIG. 2.

FIG. 5 is a front sectional view of the mixing tube of FIG. 4.

FIG. 6 is a side diagrammatic view of a portion of the engine intake system in FIG. 2, showing air and fuel passing through an engine intake system containing a mixing tube.

FIG. 7, including its blocks 7A-7F, is a diagrammatic illustration showing aspects of the engine intake system of FIG. 2 in operation, including the evacuation of fuel from the mixing tube and manifold into a cylinder.

### DETAILED DESCRIPTION

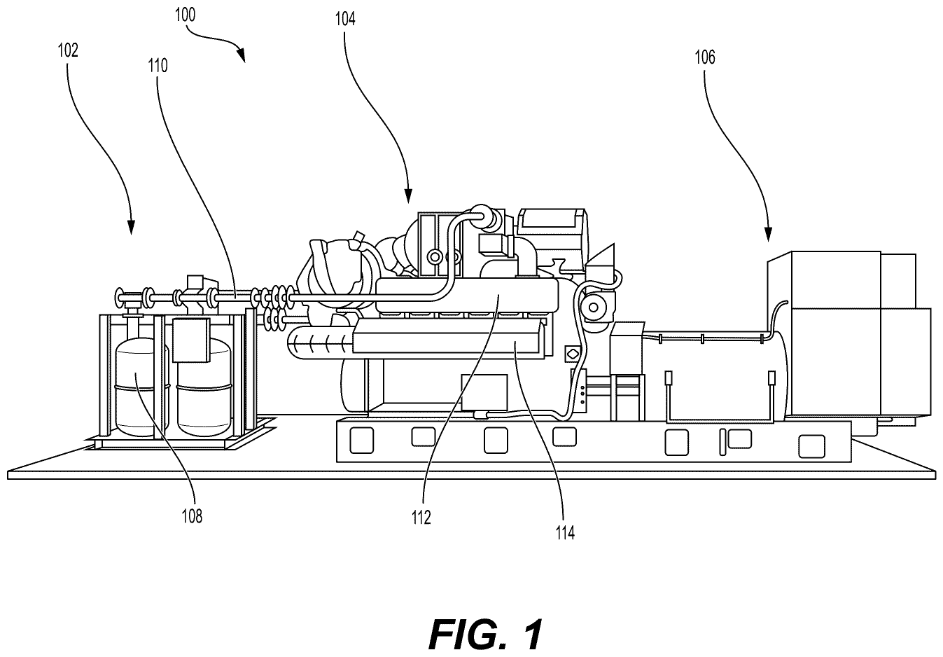

Referring to FIG. 1, there is shown a side view of a power generation unit 100, which includes a fuel supply system 102, an internal combustion engine 104, and an electrical generator 106. The power generation unit 100 combusts fuel from the fuel supply 102 within the internal combustion engine 104, which runs the generator 106 to create electrical energy.

The fuel supply system 102 is fluidly coupled to the internal combustion engine 104 and includes a supply tank 108 and a supply line 110. The fuel supply system 102 contains and delivers to the internal combustion engine 104 a fuel such as propane, natural gas, hydrogen, various blends, or others. The fuel may be stored within the supply tank 108 in a compressed gaseous or liquified state and may undergo a state change prior to being delivered to the internal combustion engine 104.

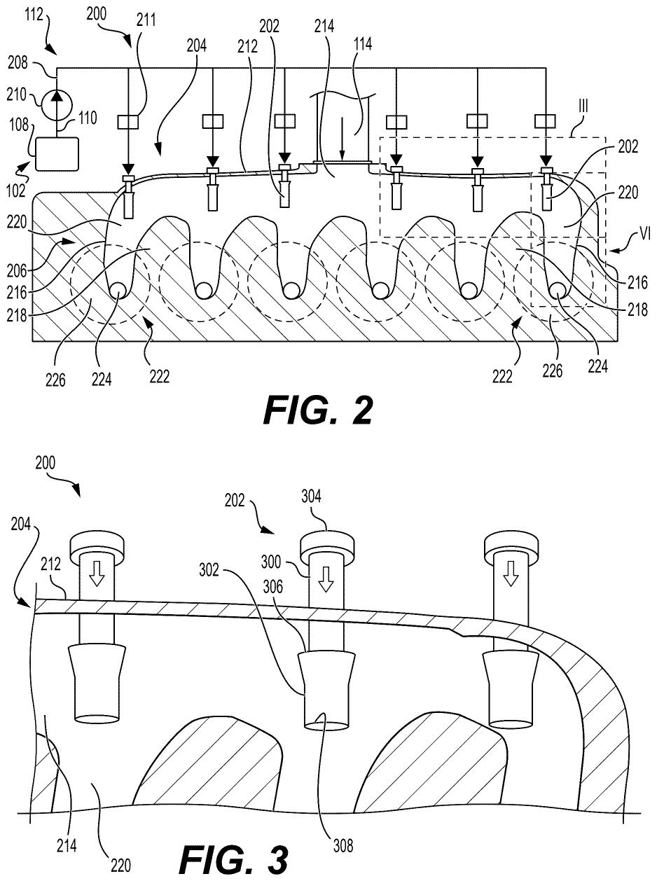

The internal combustion engine 104 is mechanically coupled to the generator 106 and includes a fuel intake system 112, an air intake system 114, and an engine intake system (as described below and shown in FIG. 2 as 200). The fuel from the fuel supply system 102 is delivered to the fuel intake system 112, and the air intake system 114 pulls in air from around the power generation unit 100. The incoming fuel and air come together and mix within the engine intake system 200 and the resulting mix is subsequently combusted.

The generator 106 captures the resulting output of the internal combustion engine 104 and generates electrical energy. That energy may be transferred to a power grid or power storage device where it may be used to power any number of devices or systems.

Turning to FIG. 2, additional details of the internal combustion engine 104 are shown, including the engine intake system 200 and a combustion system 206. The engine intake system 200 pulls in fuel from the fuel intake system 112 and air from the air intake system 114 in preparation for combustion in the combustion system 206.

The fuel supply system 102 is connected to and supplies the fuel intake system 112. The fuel supply system 102 includes the supply tank 108 for storing fuel and the supply line 110 for moving fuel to the fuel intake system 112. The fuel intake system 112 includes a fuel line 208, a fuel delivery device 210, and a plurality of fuel limiters 211. Fuel is moved from the fuel delivery device 210, through the fuel limiters 211, and to the mixing tubes 202 via the fuel line 208. The fuel line 208 is shown as a fuel manifold or common rail, which branches to provide flow paths for moving fuel to each of the mixing tubes 202. For example, and as shown, the fuel line 208 branches into six segments to move fuel to the six mixing tubes 202, each segment including a single fuel limiter 211.

The fuel delivery device 210 creates and/or maintains pressure in the fuel line 208 and may include one or more pumps, injectors, and/or valves. As shown, the fuel delivery device 210 is a fuel pump which pressurizes the fuel within the fuel line 208. The fuel limiters 211 provide and restrict fluid or gas access to the mixing tubes 202 and may include one or more valves and/or injectors. As shown, the fuel valves 211 are gas admission valves which open and close to disperse the pressurized fuel to the mixing tubes 202 via the fuel line 208.

The air intake system 114 includes one or more passageways which take air from outside of the engine intake system 200 and direct it into the manifold 204. The air intake system 114 may transport air into the manifold 204 via a pressure differential or may use a turbocharger or other device to force air into the manifold 204.

The mixing tubes 202 are each one or more tubes, and each is coupled to the fuel line 208 such that fuel is moved through one of the mixing tubes 202 prior to entering the manifold 204. Each mixing tube 202 extends through a manifold wall 212 and into a main cavity 214. The mixing tubes 202 are used to assist with directing fuel to the combustion system 206 as well as assist with evacuating fuel from the manifold 204. As shown, there are six mixing tubes 202, however the number of mixing tubes 202 may vary based on the setup of the engine intake system 200. Further, each mixing tube 202 is associated with a corresponding combustion subsystem 222, there being six of each.

The fuel intake system 112 and the air intake system 114 generally come together within the manifold 204. The manifold 204 includes the manifold wall 212, a passageway wall 216, a plurality of lobes 218, the main cavity 214, and a plurality of passageways 220. The manifold wall 212 is a wall that defines a portion of the main cavity 214. The passageway wall 216 is a wall connected to the manifold wall 212 and defines the remainder of the main cavity 214 as well as the entirety of each passageway 220. The lobes 218 are the empty space or material located between the passageways 220. The main cavity 214 is the space formed by the manifold wall 212 and part of the passageway wall 216 and is where the fuel and air are introduced into the manifold 204. Branching off the main cavity 214 and leading towards the combustion system 206 are the passageways 220, which are the spaces formed by the passageway wall 216, each passageway 220 extending from the main cavity 214 towards an intake valve 224. The engine intake system 200 is shown having six passageways 220, each generally being associated with a single mixing tube 202 and a single combustion subsystem 222. Each passageway 220 leads from the main cavity 214 to a combustion subsystem 206 and is also where the fuel and air partially mix prior to entering the combustion system 206.

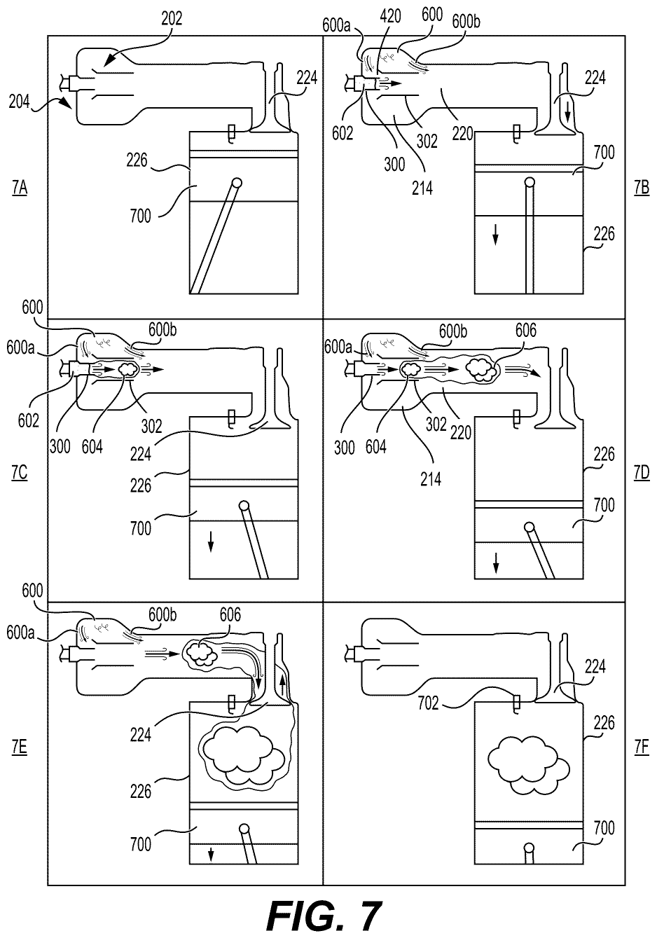

The combustion system 206 includes a plurality of combustion subsystems 222, each including the intake valve 224, a cylinder 226, and optionally an ignitor (as described below and shown in FIG. 7 as 702). As shown, there are six combustions subsystems 222 making up the combustion system 206. The intake valve 224 is a valve that provides and limits access to the cylinder 226 from the passageways 220. Each of the cylinders 226 is a cavity fluidly coupled to one of the passageways 220 through the intake valve 224 and is where a mixture of fuel and air is combusted. The ignitor 702 is used to ignite the fuel and air mixture within a cylinder 226. In some embodiments, there may not be an ignitor 702, such as when combustion occurs due to the compression of the fuel-air mixture within the cylinder 226.

Referring to FIGS. 3-5, there are shown various views of one or more mixing tubes 202. FIG. 3 shows a portion of the engine intake system 200 noted in the dashed line box labeled “III” in FIG. 2. As described above, the manifold 204 includes the manifold wall 212, main cavity 214, and passageways 220. Each mixing tube 202 is shown as an assembly including an inner tube 300 and an outer tube 302.

The inner tube 300 has a fuel inlet 304 that is positioned outside of the manifold 204 and couples to the fuel line 208 to receive fuel from the fuel supply system 102. The inner tube 300 extends through the manifold wall 212 such that it terminates within the main cavity 214.

The outer tube 302 is coupled to the inner tube 300 and is positioned fully within the main cavity 214. The outer tube 302 includes an inlet end 306 and an outlet end 308. The outer tube 302 surrounds the fuel outlet 308 of the inner tube 300, such that fuel exiting the inner tube 300 enters directly into the outer tube 302. The outlet end 308 terminates within the main cavity 214, however may also or instead terminate within the passageway 220.

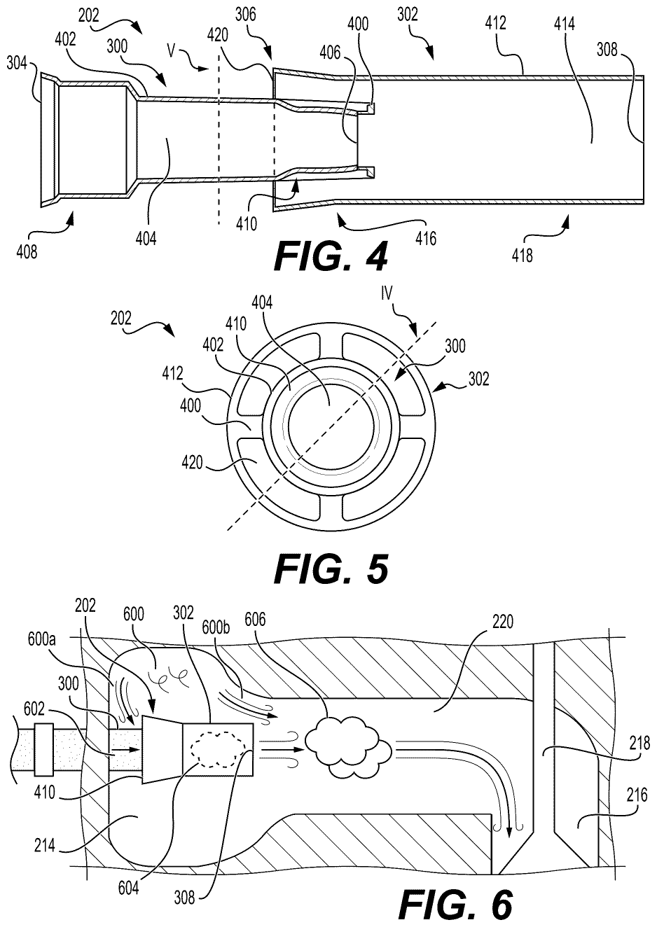

FIGS. 4 and 5 are different views of one of the mixing tubes 202. FIG. 4 shows the mixing tube 202, taken along dashed line “IV” of FIG. 5. As shown, the mixing tube 202 includes an inner tube 300 rigidly coupled to an outer tube 302 through a plurality of fins 400.

The inner tube 300 includes a first wall 402 which defines a first cavity 404, the first cavity 404 extending between the fuel inlet 304 and a fuel outlet 406 such that fuel entering the fuel inlet 304 passes through the first cavity 404 prior to exiting the fuel outlet 406. The inner tube 300 includes a fuel inlet section 408 adjacent to the fuel inlet 304 as well as a fuel outlet section 410 adjacent to the fuel outlet 406, the fuel outlet 406 positioned within the main cavity 214. The fuel outlet section 410 is shown as tapered. The fuel inlet section 408 connects with the fuel line 208.

The outer tube 302 includes a second wall 412 which defines a second cavity 414, the second cavity 414 extending between the inlet end 306 and the outlet end 308 such that fuel or air entering the inlet end 306 passes through the second cavity 414 prior to exiting the outlet end 308. The outer tube 302 includes an inlet end section 416 adjacent to the inlet end 306 as well as an outlet end section 418 adjacent to the outlet end 308. The inlet end section 416 is shown surrounding the fuel outlet section 410. The inlet end section 416 is shown as flared and includes an air inlet 420 which includes the area extending radially around the fuel outlet section 410 of the inner tube 300. The air inlet 420 is shown open to the main cavity 214 and allows air to pass from the main cavity 214 into the second cavity 414 of the outer tube 302. The taper of the fuel outlet section 410 and the flare of the inlet end section 416 generally influence the size of the air inlet 420. The outlet end section 418 is positioned such that it directs the fuel exiting the mixing tube 202 into the main cavity 214 and towards one of the passageways 220.

The fins 400 are supports which connect the exterior of the first wall 402 of the fuel outlet section 410 to the interior of the second wall 412 of the inlet end section 416, such that the fuel outlet section 410 is generally positioned within the inlet end section 416. Although shown as extending from the air inlet 420 to the fuel outlet 406, the fins 400 may be connected in any arrangement such that the first wall 402 and second wall 412 are connected.

Although shown as tapered and flared, the fuel outlet section 410 and/or inlet end section 416 may be any number of configurations. Further, changes in tube shape and/or size are not restricted to the various sections, 408, 410, 416, 418, as any portion of the mixing tube 202 may be changed to promote mixing, flow, or other characteristics. Additionally, the fuel inlet section 408 is configured such that it couples to one or more of a fuel line, injector, or valve.

FIG. 5 shows the mixing tube 202, taken along dashed line “V” of FIG. 4. Again, the mixing tube 202 includes the inner tube 300 coupled to the outer tube 302 through the plurality of fins 400. The air inlets 420 are separated from the first cavity 404 by the first wall 402. Accordingly, air enters the outer tube 302 through the air inlets 420, and fuel enters the outer tube 302 separately after flowing through the fuel outlet 406 of the inner tube 300, such that the air and fuel first come into contact within the outer tube 302.

FIG. 6 shows movement of air 600 and fuel 602 within a portion of the engine intake system 200 during operation, noted in the dashed line box labeled “VI” in FIG. 2. As shown, the mixing tube 202 is positioned such that the air 600 within the main cavity 214 interacts with the mixing tube 202.

The fuel 602 flows into the mixing tube 202 and travels through the inner tube 300.

While in the inner tube 300, the fuel 602 travels past the manifold wall 212 and into the main cavity 214, eventually exiting the inner tube 300 into the outer tube 302. A first air portion 600a moves from the main cavity 214 into the outer tube 302.

While within the outer tube 302, the fuel 602 and first air portion 600a meet and form a first mixture, generally indicated at 604. First mixture 604 may be rich and/or poorly mixed, as the fuel 602 and first air portion 600a are simply moving in the same space towards the opened intake valve 224. Further, portions of the first mixture 604 may be entirely unmixed, and such portions may be entirely fuel 602 or the first air portion 600a. The first mixture 604 exits the outer tube 302 at the outlet end 308 and into the main cavity 214.

While within the main cavity 214, the first mixture 604 may combine with a second air portion 600b to form a second mixture, generally indicated at 606. Although leaner and better mixed than the first mixture 604, the second mixture 606 may be similarly generally rich and/or poorly mixed. The second mixture 606 travels through the passageway 220 towards the opened intake valve 224.

Although the fuel 602, first mixture 604, and the second mixture 606 are illustrated as individual portions, generally these portions are each various stages of an injected charge of fuel as it moves through the main cavity 214 and passageways 220. Accordingly, the charge of fuel may be at multiple stages at once, as can be seen in FIGS. 7D-7E.

### INDUSTRIAL APPLICABILITY

FIG. 7 shows aspects of the engine intake system 200 of FIG. 2 at various positions of operation, focusing on features of an associated mixing tube 202 and combustion subsystem 222. As will be described further, the structure and positioning of the mixing tubes 202 assists with removing residual fuel and fuel-air mixtures from the mixing tube 202 as well as the manifold 204.

As shown in block 7A, a piston 700 is at the top of the cylinder 226 after a combusted fuel-air mixture has been pushed out of the cylinder 226. The intake valve 224 is closed, such that nothing is entering or exiting the mixing tube 202 or moving through the manifold 204 towards the cylinder 226. The cylinder 226 is shown ready to receive fresh fuel and air for eventual combustion.

As shown in block 7B, the piston 700 has moved down from the top of the cylinder 226, the intake valve 224 has moved toward an open configuration, and fuel 602 is shown moving into the inner tube 300 of the mixing tube 202. The opening of the intake valve 224 creates access to the cylinder 226 from the main cavity 214 through the passageway 220, and the cylinder 226 has a lower pressure than the manifold 204. The movement of the piston 700, combined with the lower pressure in the now-accessible cylinder 226, begins to pull the air 600 and fuel 602 through the manifold 204 and towards the cylinder 226. The first air portion 600a begins to move into the outer tube 302 via the air inlet 420, while the second air portion 600b moves around the mixing tube 202, generally toward the passageway 220.

As shown in block 7C, some of the fuel 602 has made its way through the inner tube 300 and into the outer tube 302. The fuel within the outer tube 302 combines with the first air portion 600a to form the first mixture 604. The first mixture 604 is shown moving towards the cylinder 226.

As shown in block 7D, the movement of fuel 602 into the inner tube 300 has ceased, however air 600 is still being provided to the manifold 204. The fuel delivery device 210 (as shown and described in FIG. 2) has been closed, preventing fuel from making its way into the inner tube 300. The unmixed fuel 602 previously in the inner tube 300 as depicted in block 7C has moved into the outer tube 302 to form first mixture 604. A portion of the first mixture 604 has made its way through the outer tube 302, and into the main cavity 214 and has combined with the air 600 within the main cavity 214 and forms a second mixture 606. The second mixture 606 is shown moving in the passageway 220 towards the cylinder 226.

As shown in block 7E, although fuel 602 is no longer being provided from the inner tube 300 to the outer tube 302, air 600 is still entering the main cavity 214 and thus first air portion 600a continues moving into and through the outer tube 302. Accordingly, the first air portion 600a displaces the first mixture 604 into the main cavity 214 to form the second mixture 606. In other words, the movement of first air portion 600a into the outer tube 302 causes the first mixture 604 to move out of the outer tube 302 and into the main cavity 214 to form the second mixture 606. As such, the outer tube 302 is filled with air from the first air portion 600a so that the outer tube 302 contains very little, if any, fuel 602. The second mixture 606 is generally moved from the main cavity 214 into the passageway 220, past the intake valve 224, and into the cylinder 226. The intake valve 224 is shown moving toward a closed configuration, which begins to cut off access to the cylinder 226 from the passageway 220.

As shown in block 7F, the piston 700 is at the bottom of the cylinder 226 and the intake valve 224 is fully closed. As there is no longer access to the cylinder 226 from the manifold 204, the flow of air 600, and any fuel 602 or mixture, 604 and 606, towards or into the cylinder 226 has ceased. As only air 600 was provided to the manifold 204 and mixing tube 202 during the activity of block 7E, and that air 600 has evacuated the fuel 602 and mixtures, 604 and 606, into the cylinder 226, little to no fuel 602 or mixtures 604 or 606 should remain within the mixing tube 202 or manifold 204. The cylinder 226 is shown as ready to compress and combust the mixture of fuel and air with ignitor 702.

While the outlet end 308 was described as located within the main cavity 214, depending on the size of the various portions of the mixing tube 202, the outlet end 308 may instead or additionally be located within the passageway 220. Further, the combination of the air 600 and fuel 602 forming the second mixture 606 may happen within the main cavity 214, the passageway 220, or both.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of the disclosure. Such embodiments should be understood to fall within the scope of the present disclosure as determined based upon the claims and any equivalents thereof.

1. A mixing tube assembly for delivering fuel to an internal combustion engine having an intake manifold including a manifold wall and defining a manifold cavity, the mixing tube assembly comprising:
a first tube configured to extend from outside the manifold wall into the manifold cavity and including:
a first end segment configured to receive a charge of fuel from a fuel injector and to be positioned outside the manifold; and
a second end segment opposite the first end segment and configured to be positioned within the manifold cavity; and
a second tube configured to be positioned entirely within the manifold cavity and including:
a third end segment receiving the second end segment and including an opening in communication with the manifold cavity; and
a fourth end segment opposite the third end segment and in communication with the manifold cavity;
wherein the mixing tube assembly is configured such that after cessation of injection of the charge of fuel into the first tube, air from within the manifold cavity continues entering the second tube through the opening and continues flowing through the second tube to evacuate residual fuel from the second tube.

2. The mixing tube assembly of claim 1, wherein the second end segment extends into the opening and terminates within the second tube.

3. The mixing tube assembly of claim 2, wherein an outer surface of the second end segment and an inner surface of the third end segment are rigidly coupled such that the first tube and second tube form a unitary structure.

4. The mixing tube assembly of claim 3, further including a plurality of fins extending directly from the outer surface to the inner surface, the plurality of fins defining a plurality of air inlets in the opening, wherein the mixing tube assembly is configured such that during operation of the internal combustion engine, air from within the manifold cavity flows through the plurality of air inlets.

5. The mixing tube assembly of claim 1, wherein the second tube is further configured to carry the charge of fuel out of the fourth end segment and into the manifold cavity.

6. The mixing tube assembly of claim 1, wherein the first tube is positioned between the first and second end segments and configured to rigidly couple with the manifold wall.

7. The mixing tube assembly of claim 1, wherein the fourth end segment of the mixing tube assembly is positioned within the manifold cavity such that the charge of fuel is directed towards a cylinder having a piston.

8. The mixing tube assembly of claim 1, wherein the second end segment includes a tapered section such that a diameter of the first tube decreases throughout the tapered section.

9. The mixing tube assembly of claim 1, wherein a diameter of the second tube is larger than a diameter of the first tube.

10. An internal combustion engine, comprising:
a cylinder;
a manifold fluidly coupled to the cylinder and configured to provide air to the cylinder, the manifold including a manifold wall and a manifold cavity;
an intake valve controlling the flow of material from the manifold cavity into the cylinder;
a mixing tube assembly including:
an inner tube coupled to the manifold, including a fuel inlet positioned outside of the manifold cavity and a fuel outlet positioned within the manifold cavity;
an outer tube positioned entirely within the manifold cavity and including:
an inlet end having larger diameter than the fuel outlet and being fixedly coupled to the inner tube such that the fuel outlet is entirely within the outer tube, the inlet end further having an air inlet through which air from the manifold cavity passes into the inlet end; and
an outlet end opening into the manifold cavity before the intake valve; and
an injector coupled to the fuel inlet and providing fuel to the inner tube;
wherein during operation of the internal combustion engine, air from the manifold enters the outer tube through the air inlet and establishes a flow through the outer tube, the flow drawing fuel in the inner tube into the outer tube and carrying the fuel through the outer tube and into the manifold cavity, the mix then joining air in the manifold cavity and being drawn past the intake valve and into the cylinder.

11. The internal combustion engine of claim 10, the fuel outlet including an outer surface and the air inlet including an inner surface, the outer surface and inner surface being rigidly coupled such that the inner tube and outer tube form a unitary structure.

12. The internal combustion engine of claim 11, the inner tube further including a terminal end proximate the fuel outlet and the outer tube further including a terminal end proximate the air inlet, and further including a plurality of fins extending directly between the terminal ends.

13. The internal combustion engine of claim 10, the inner tube including a threaded segment rigidly coupled to the manifold wall.

14. The internal combustion engine of claim 10, the cylinder including an ignitor for igniting the fuel during operation of the internal combustion engine.

15. The internal combustion engine of claim 10, the inner tube including a tapered section such that a diameter of the inner tube decreases at the fuel outlet.

16. A method of delivering fuel to an internal combustion engine having an intake valve, a cylinder, a manifold defining a manifold cavity, a mixing tube having an air inlet in constant and unblocked fluid communication with the manifold cavity, and a fuel injector, the method comprising:
opening the intake valve and beginning an intake stroke;
operating the fuel injector to inject a fuel into the mixing tube;
moving air from the manifold cavity into the mixing tube through an opening in the mixing tube;
combining the fuel in the mixing tube with the air in the mixing tube to form a first mixture;
moving the first mixture from the mixing tube into the manifold cavity;
combining the first mixture with air in the manifold cavity to form a second mixture;
operating the fuel injector to stop injection of the fuel into the mixing tube;
moving the second mixture from the manifold cavity into the cylinder;
moving air from within the manifold into the mixing tube to evacuate residual fuel from the mixing tube; and
closing the intake valve and ending the intake stroke.

17. The method of claim 16, wherein the mixing tube includes a first tube and a second tube, the first tube having an inlet end positioned outside of the manifold and in communication with the fuel injector and an outlet end, and the second tube being positioned entirely within the manifold cavity and having an inlet end and an outlet end, the opening of the mixing tube being defined generally at the inlet end of the second tube, and wherein the step of moving air from the manifold cavity into the mixing tube includes moving air into the second tube.

18. The method of claim 17, wherein after the injector is closed, the first portion of air pulls the residual fuel from the first tube, through the second tube, and into the manifold.

19. The method of claim 18, wherein first and second portions of air pull the residual fuel from the manifold into the cylinder prior to the intake valve closing.

20. The method of claim 19, further including the step of compressing the fuel within the cylinder and combusting it.
